(19) United States
(12) Patent Application Publication
(10) Pub. No.: US 2020/0372426 A1
(43) Pub. Date: Nov. 26, 2020

(54) Tracking of and Coordination Among Technicians, Vehicles, and Inventory

(71) Applicant: CenturyLink Intellectual Property LLC, Broomfield, CO (US)

(72) Inventors: William Joseph Keaton, Yardley, PA (US); David Jason Moore, Lakewood Ranch, FL (US)

(21) Appl. No.: 16/595,204

(22) Filed: Oct. 7, 2019

Related U.S. Application Data
(60) Provisional application No. 62/850,072, filed on May 20, 2019.

(51) Int. Cl. G06Q 10/06; G06Q 10/08; G06Q 10/04; H04W 4/02; G08G 1/00; G01W 1/10

(52) U.S. Cl. CPC G06Q 10/06313; G06Q 10/0633; G06Q 10/063112; G06Q 10/0875; G06Q 50/01; H04W 4/02; G08G 1/202; G01W 1/10; G06Q 10/047

(57) ABSTRACT

Novel tools and techniques are provided for implementing logistical coordination, e.g., tracking of and coordination among technicians, vehicles, and inventory. In various embodiments, a computing system might receive, from a user device associated with a first user, a first request for information regarding a first task; might determine a current location of the user device; might compile information regarding the first task that is obtained from a database(s); might identify first equipment necessary and first location(s) for completing or performing the first task, based on the compiled information; might identify first storage locations that have adequate supplies of the identified first equipment and that are within a predetermined distance from the current location of the user device and/or the first location(s); and might generate and display, on the user device, user interface screens displaying the compiled information regarding the first task and displaying a map view depicting the various locations.

### CROSS-REFERENCES TO RELATED APPLICATIONS

This application claims priority to U.S. Patent Application Ser. No. 62/850,072 (the “'072 Application”), filed May 20, 2019 by William Joseph Keaton et al. (attorney docket no. 1540-US-P1), entitled, “Method and System for Implementing Tracking of and Coordination Among Technicians, Vehicles, and Inventory,” the disclosure of which is incorporated herein by reference in its entirety for all purposes.

This application may be related to U.S. patent application Ser. No. 16/363,918 (the “'918 Application”), filed Mar. 25, 2019 by Ronald A. Lewis (attorney docket no. 1526-US-U1), entitled, “Method and System for Implementing Intelligence Enabled Things (IET),” which claims priority to U.S. Patent Application Ser. No. 62/792,753 (the “'753 Application”), filed Jan. 15, 2019 by Ronald A. Lewis (attorney docket no. 1526-US-P1), entitled, “Method and System for Implementing Intelligence Enabled Things (IET),” the disclosure of each of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing logistical coordination, and, more particularly, to methods, systems, and apparatuses for implementing tracking of and coordination among technicians, vehicles, and inventory.

### BACKGROUND

Conventional systems do not enable tracking and coordinating amongst at least one of one or more users or technicians, one or more vehicles, one or more inventory equipment or other equipment, and/or one or more locations at which tasks are to be performed, and/or the like.

Hence, there is a need for more robust and scalable solutions for implementing logistical coordination, and, more particularly, to methods, systems, and apparatuses for implementing tracking of and coordination among technicians, vehicles, and inventory.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing tracking of and coordination among technicians, vehicles, and inventory, in accordance with various embodiments.

FIG. 2 is a schematic diagram illustrating a non-limiting example of technician actions and system interactions when implementing tracking of and coordination among technicians, vehicles, and inventory, in accordance with various embodiments.

FIG. 3 is a schematic diagram illustrating a non-limiting example of user device depicting a geographic area in which tracking of and coordination among technicians, vehicles, and inventory may be implemented, along with display of example information fields, in accordance with various embodiments.

FIGS. 4A-4C are flow diagrams illustrating a method for implementing tracking of and coordination among technicians, vehicles, and inventory, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing logistical coordination, and, more particularly, to methods, systems, and apparatuses for implementing tracking of and coordination among technicians, vehicles, and inventory.

In various embodiments, a computing system might receive, from a user device associated with a first user, a first request for information regarding a first task; might determine a current location of the user device associated with the first user; might access one or more first databases to obtain information regarding the first task, in response to receiving the first request; and might compile the information regarding the first task that is obtained from the one or more first databases. The computing system might identify one or more first equipment necessary for completing the first task, based at least in part on the compiled information regarding the first task; might identify one or more first locations for performing the first task, based at least in part on the compiled information regarding the first task; and might identify one or more first storage locations that have adequate supplies of the identified one or more first equipment and that are within a predetermined distance from one of the current location of the user device associated with the first user or at least one first location among the one or more first locations, based at least in part on the compiled information regarding the first task. The computing system might generate and display, on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user, and/or the like.

In some embodiments, the computing system might identify one or more second users who are capable of assisting the first user in performance of the first task or performance of one or more second tasks that are related to performance of the first task, based at least in part on the compiled information regarding the first task; might identify a current location for each of the identified one or more second users, based at least in part on the compiled information regarding the first task; might access, from a second database, contact information for each of the identified one or more second users; and might provide, through at least one user interface screen of the generated one or more user interface screens, an option to contact each of at least one second user among the one or more identified one or more second users, based on contact information for the at least one second user. In such cases, the one or more user interface screens further display at least one of information regarding the at least one second user and a map view depicting a current location of each of the at least one second user.

According to some embodiments, the identified one or more second users might include, without limitation, at least one of a technician who is qualified to work on the first task, a technician who is qualified to operate at least one of the identified one or more first equipment, an expert on use of at least one of the identified one or more first equipment, a user familiar with ordering more of at least one of the identified one or more first equipment, a technician familiar with working at one or more of the identified one or more first locations, a user familiar with at least one of the identified one or more first storage locations, or a sales representative for handling sales-related questions arising during the first task, and/or the like. In some cases, providing the option to contact each of the at least one second user might include, but is not limited to, at least one of providing an option to contact each of the at least one second user via telephone, providing an option to contact each of the at least one second user via e-mail, providing an option to contact each of the at least one second user via a short message service (“SMS”) message, providing an option to contact each of the at least one second user via instant messaging, providing an option to contact at least two of the one or more second users via group messaging, or providing an option to contact at least two of the one or more second users via broadcast messaging, and/or the like.

In some embodiments, the computing system might identify one or more first vehicles that are at least one of suitable for performing the first task or suitable for transporting the identified one or more first equipment and that are within a predetermined distance from the current location of the user device associated with the first user, based at least in part on the compiled information regarding the first task. In such cases, the one or more user interface screens might further display at least one of information regarding at least one of the identified one or more first vehicles and a map view depicting a location of each of the identified one or more first vehicles relative to the current location of the user device associated with the first user. In some instances, the computing system might assign a first vehicle to the first user from among the identified one or more first vehicles. In some cases, the computing system might generate an itinerary for the first user, the itinerary comprising mapped routes from one to another of the current location of the user device associated with the first user, a location of the assigned first vehicle, at least one of the identified one or more first storage locations for pickup of the identified one or more first equipment, and each of the identified one or more first locations for completing the first task. According to some embodiments, the computing system might track locations of each of the identified one or more first equipment and/or might track locations of each of the identified one or more first vehicles.

Merely by way of example, in some cases, the computing system might monitor, based on one or more weather information sources, current and impending weather conditions around each of at least one of the current location of the user device associated with the first user, the identified one or more first locations for performing the first task, the identified one or more first storage locations, or one or more routes between two or more locations among the at least one of the current location of the user device associated with the first user, the identified one or more first locations for performing the first task, the identified one or more first storage locations; might determine whether the monitored current and impending weather conditions would have an impact on performance of the first task; and based on a determination that the monitored current and impending weather conditions exceeds a predetermined probability of impacting performance of the first task, might generate and display, on the user device associated with the first user, at least one of one or more weather alerts, one or more changes to the first task, or one or more updated user interface screens highlighting changes due to the monitored current and impending weather conditions, and/or the like.

According to some embodiments, the computing system might generate and display, on one or more display devices, one or more group interface screens to enable one or more third users to access the compiled information regarding the first task and the map view depicting the at least one of the identified one or more first locations, the identified one or more first storage locations, or the current location of the user device associated with the first user, the one or more third users comprising each of the at least one of a manager or one or more group members tasked with performing the first task.

In this manner, the system and method can track and coordinate amongst at least one of one or more users or technicians, one or more vehicles, one or more inventory equipment or other equipment, and/or one or more locations at which tasks are to be performed, and/or the like.

These and other aspects of the system and method for tracking and coordinating among technicians, vehicles, and inventory are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, equipment tracking technology, user or group tracking technology, logistical coordination technology, task coordination technology, user or group coordination technology, and/or the like. In other aspects, certain embodiments, can improve the functioning of user equipment or systems themselves (e.g., equipment tracking systems, user or group tracking systems, logistical coordination systems, task coordination systems, user or group coordination systems, etc.), for example, by receiving, with a computing system and from a user device associated with a first user, a first request for information regarding a first task; determining, with the computing system, a current location of the user device associated with the first user; in response to receiving the first request, accessing, with the computing system, one or more first databases to obtain information regarding the first task; compiling, with the computing system, the information regarding the first task that is obtained from the one or more first databases; identifying, with the computing system, one or more first equipment necessary for completing the first task, based at least in part on the compiled information regarding the first task; identifying, with the computing system, one or more first locations for performing the first task, based at least in part on the compiled information regarding the first task; identifying, with the computing system, one or more first storage locations that have adequate supplies of the identified one or more first equipment and that are within a predetermined distance from one of the current location of the user device associated with the first user or at least one first location among the one or more first locations, based at least in part on the compiled information regarding the first task; and generating and displaying, with the computing system and on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user; and/or the like.

In particular, to the extent any abstract concepts are present in the various embodiments, those concepts can be implemented as described herein by devices, software, systems, and methods that involve specific novel functionality (e.g., steps or operations), such as, tracking and coordinating amongst at least one of one or more users or technicians, one or more vehicles, one or more inventory equipment or other equipment, and/or one or more locations at which tasks are to be performed, and/or the like, to name a few examples, that extend beyond mere conventional computer processing operations. These functionalities can produce tangible results outside of the implementing computer system, including, merely by way of example, optimized workflow and results including reduced inventory costs, increased productivity, improved efficiency, and/or fewer missed commitments, and/or the like, at least some of which may be observed or measured by customers and/or service providers.

In an aspect, a method might comprise receiving, with a computing system and from a user device associated with a first user, a first request for information regarding a first task; determining, with the computing system, a current location of the user device associated with the first user; in response to receiving the first request, accessing, with the computing system, one or more first databases to obtain information regarding the first task; and compiling, with the computing system, the information regarding the first task that is obtained from the one or more first databases. The method might also comprise identifying, with the computing system, one or more first equipment necessary for completing the first task, based at least in part on the compiled information regarding the first task; identifying, with the computing system, one or more first locations for performing the first task, based at least in part on the compiled information regarding the first task; and identifying, with the computing system, one or more first storage locations that have adequate supplies of the identified one or more first equipment and that are within a predetermined distance from one of the current location of the user device associated with the first user or at least one first location among the one or more first locations, based at least in part on the compiled information regarding the first task. The method might further comprise generating and displaying, with the computing system and on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user.

In some embodiments, the computing system might comprise one of a processor of the user device running a software application (“app”), a workflow control system, a workflow coordination system, a server computer over a network, a cloud-based computing system over a network, or a distributed computing system, and/or the like. In some cases, the user device might comprise at least one of a tablet computer, a laptop computer, a smart phone, or a mobile phone, and/or the like.

According to some embodiments, the method might further comprise identifying, with the computing system, one or more second users who are capable of assisting the first user in performance of the first task or performance of one or more second tasks that are related to performance of the first task, based at least in part on the compiled information regarding the first task; identifying, with the computing system, a current location for each of the identified one or more second users, based at least in part on the compiled information regarding the first task; accessing, with the computing system and from a second database, contact information for each of the identified one or more second users; providing, with the computing system and through at least one user interface screen of the generated one or more user interface screens, an option to contact each of at least one second user among the one or more identified one or more second users, based on contact information for the at least one second user. In such cases, the one or more user interface screens might further display at least one of information regarding the at least one second user and a map view depicting a current location of each of the at least one second user.

In some cases, the identified one or more second users might comprise at least one of a technician who is qualified to work on the first task, a technician who is qualified to operate at least one of the identified one or more first equipment, an expert on use of at least one of the identified one or more first equipment, a user familiar with ordering more of at least one of the identified one or more first equipment, a technician familiar with working at one or more of the identified one or more first locations, a user familiar with at least one of the identified one or more first storage locations, or a sales representative for handling sales-related questions arising during the first task, and/or the like. In some instances, providing the option to contact each of the at least one second user might comprise at least one of providing an option to contact each of the at least one second user via telephone, providing an option to contact each of the at least one second user via e-mail, providing an option to contact each of the at least one second user via a short message service (“SMS”) message, providing an option to contact each of the at least one second user via instant messaging, providing an option to contact at least two of the one or more second users via group messaging, or providing an option to contact at least two of the one or more second users via broadcast messaging, and/or the like.

In some embodiments, displaying the compiled information regarding the first task might comprise displaying detailed information regarding each of the identified one or more first equipment, the detailed information comprising at least one of part category, model number, serial number, brief description, a schematic diagram of the first equipment or a photograph of the first equipment, and/or the like.

According to some embodiments, the method might further comprise identifying, with the computing system, one or more first vehicles that are at least one of suitable for performing the first task or suitable for transporting the identified one or more first equipment and that are within a predetermined distance from the current location of the user device associated with the first user, based at least in part on the compiled information regarding the first task. In such cases, the one or more user interface screens might further display at least one of information regarding at least one of the identified one or more first vehicles and a map view depicting a location of each of the identified one or more first vehicles relative to the current location of the user device associated with the first user.

In some embodiments, the method might further comprise assigning, with the computing system, a first vehicle to the first user from among the identified one or more first vehicles. In some cases, the method might further comprise generating, with the computing system, an itinerary for the first user, the itinerary comprising mapped routes from one to another of the current location of the user device associated with the first user, a location of the assigned first vehicle, at least one of the identified one or more first storage locations for pickup of the identified one or more first equipment, and each of the identified one or more first locations for completing the first task.

According to some embodiments, the method might further comprise at least one of tracking, with the computing system, locations of each of the identified one or more first equipment; or tracking, with the computing system, locations of each of the identified one or more first vehicles. In some instances, each first equipment among the identified one or more first equipment might comprise an equipment tag having a unique first identifier associated with said first equipment, wherein each first vehicle among the identified one or more first vehicles might comprise a vehicle tag having a unique second identifier associated with said first vehicle, wherein tracking locations of each of the identified one or more first equipment might comprise at least one of using a scanner at one or more locations to scan the unique first identifier associated with each first equipment when said first equipment arrives at each location or using a location tracking device disposed on each first equipment, wherein tracking locations of each of the identified one or more first vehicles might comprise at least one of using a scanner at one or more locations to scan the unique second identifier associated with each first vehicle when said first vehicle arrives at each location or using a location tracking device disposed on each first vehicle.

In some embodiments, the method might further comprise monitoring, with the computing system and based on one or more weather information sources, current and impending weather conditions around each of at least one of the current location of the user device associated with the first user, the identified one or more first locations for performing the first task, the identified one or more first storage locations, or one or more routes between two or more locations among the at least one of the current location of the user device associated with the first user, the identified one or more first locations for performing the first task, the identified one or more first storage locations; determining, with the computing system, whether the monitored current and impending weather conditions would have an impact on performance of the first task; and based on a determination that the monitored current and impending weather conditions exceeds a predetermined probability of impacting performance of the first task, generating and displaying, with the computing system and on the user device associated with the first user, at least one of one or more weather alerts, one or more changes to the first task, or one or more updated user interface screens highlighting changes due to the monitored current and impending weather conditions.

According to some embodiments, the method might further comprise generating and displaying, with the computing system and on one or more display devices, one or more group interface screens to enable one or more third users to access the compiled information regarding the first task and the map view depicting the at least one of the identified one or more first locations, the identified one or more first storage locations, or the current location of the user device associated with the first user, the one or more third users comprising each of the at least one of a manager or one or more group members tasked with performing the first task.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive, from a user device associated with a first user, a first request for information regarding a first task; determine a current location of the user device associated with the first user; in response to receiving the first request, access one or more first databases to obtain information regarding the first task; compile the information regarding the first task that is obtained from the one or more first databases; identify one or more first equipment necessary for completing the first task, based at least in part on the compiled information regarding the first task; identify one or more first locations for performing the first task, based at least in part on the compiled information regarding the first task; identify one or more first storage locations that have adequate supplies of the identified one or more first equipment and that are within a predetermined distance from one of the current location of the user device associated with the first user or at least one first location among the one or more first locations, based at least in part on the compiled information regarding the first task; and generate and display, on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user.

In some embodiments, the apparatus might comprise one of a processor of the user device running a software application (“app”), a workflow control system, a workflow coordination system, a server computer over a network, a cloud-based computing system over a network, or a distributed computing system, and/or the like.

In yet another aspect, a system might comprise a user device associated with a first user and a computing system. The user device might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the user device to: send a first request for information regarding a first task; and send location information regarding the user device.

The computing system might comprise at least one second processor and a second non-transitory computer readable medium communicatively coupled to the at least one second processor. The second non-transitory computer readable medium might have stored thereon computer software comprising a second set of instructions that, when executed by the at least one second processor, causes the computing system to: receive, from the user device associated with the first user, the first request for information regarding a first task; determine a current location of the user device associated with the first user based on the location information regarding the user device that is received from the user device; in response to receiving the first request, access one or more first databases to obtain information regarding the first task; compile the information regarding the first task that is obtained from the one or more first databases; identify one or more first equipment necessary for completing the first task, based at least in part on the compiled information regarding the first task; identify one or more first locations for performing the first task, based at least in part on the compiled information regarding the first task; identify one or more first storage locations that have adequate supplies of the identified one or more first equipment and that are within a predetermined distance from one of the current location of the user device associated with the first user or at least one first location among the one or more first locations, based at least in part on the compiled information regarding the first task; and generate and display, on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user.

According to some embodiments, the computing system might comprise one of a processor of the user device running a software application (“app”), a workflow control system, a workflow coordination system, a server computer over a network, a cloud-based computing system over a network, or a distributed computing system, and/or the like.

In still another aspect, a method might comprise tracking and coordinating among at least one of one or more users, one or more vehicles, or one or more inventory equipment for assisting the one or more users in performing one or more tasks.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

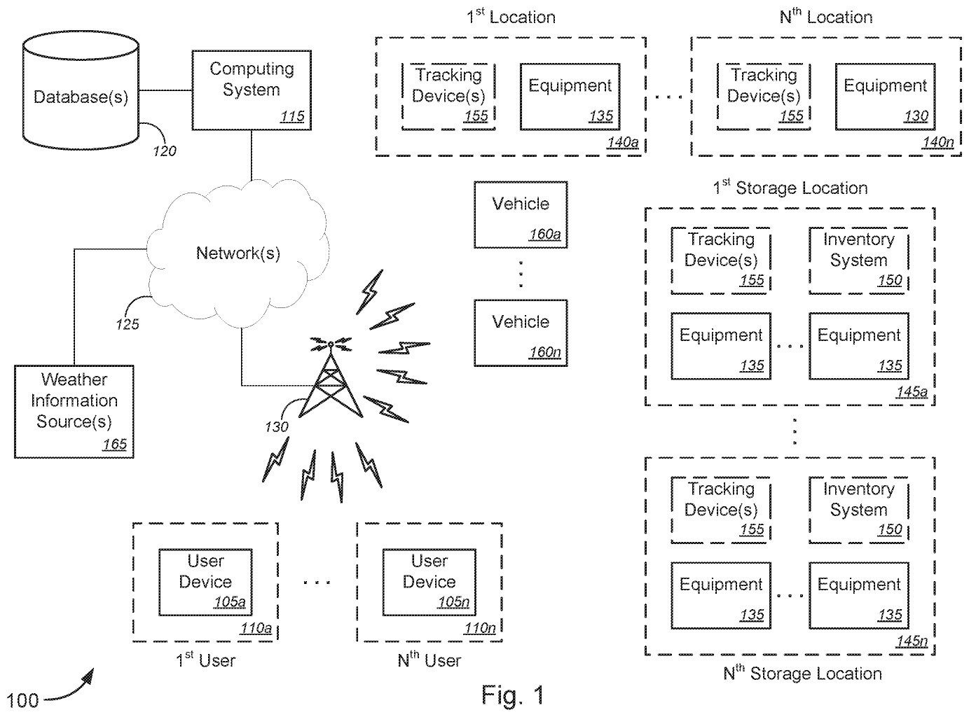

We now turn to the embodiments as illustrated by the drawings. FIGS. 1-6 illustrate some of the features of the method, system, and apparatus for implementing logistical coordination, and, more particularly, to methods, systems, and apparatuses for implementing tracking of and coordination among technicians, vehicles, and inventory, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing tracking of and coordination among technicians, vehicles, and inventory, in accordance with various embodiments.

In the non-limiting embodiment of FIG. 1, system 100 might comprise one or more user devices 105a-105n (collectively, “user devices 105” or the like) each associated with first through N^{th} users 110a-110n (collectively, “users 110” or the like). In some embodiments, the user devices 105 might each include, without limitation, at least one of a tablet computer, a laptop computer, a smart phone, or a mobile phone, and/or the like. System 100 might further comprise computing system 115 and corresponding database(s) 120 that might communicatively couple with each user device 105 via network(s) 125 (and in some cases, in some cases, via one or more telecommunications relay systems 130, which might include, without limitation, one or more wireless network interfaces (e.g., wireless modems, wireless access points, and the like), one or more towers, one or more satellites, and/or the like)). According to some embodiments, computing system 115 might include, but is not limited to, one of a processor of the user device running a software application (“app”), a workflow control system, a workflow coordination system, a server computer over a network, a cloud-based computing system over a network, or a distributed computing system, and/or the like.

According to some embodiments, the network(s) 125 might each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 125 might each include an access network of the service provider (e.g., an Internet service provider (“ISP”)). In another embodiment, the network(s) 125 might each include a core network of the service provider, and/or the Internet.

System 100 might further comprise equipment 135 that may be used by the user(s) 110 for performing one or more tasks at one or more of first through N^{th} locations 140a-140n (collectively, “locations 140” or the like), which might each include, without limitation, one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, an industrial building or complex, a construction site, or other worksite, and/or the like. System 100 might further comprise first through N^{th} storage locations 145a-145n (collectively, “storage location 145” or the like), at which equipment 135 may be stored when not in use. System 100 might further comprise an inventory system 150 (optional) at each of one or more of the storage locations 145 for tracking inventory with respect to at least the equipment that is being stored (or available) at each such storage location. System 100 might further comprise one or more tracking devices 155, which each might include, but is not limited to, one of a scanner that may be used to scan a unique identifier associated with each equipment 135 when said equipment 135 arrives at each location 140 or 145 or a location tracking device that is disposed on each equipment 135 (and that may communicate autonomously with the scanner or wirelessly with computing system 115 via network(s) 125 (and in some cases, via telecommunications relay system 130), or the like). In some cases, the one or more tracking devices 155 might each comprise location detection systems (e.g., GPS or the like) to determine the location of the tracking device (whether embodied as a scanner or embodied as a location tracking tag or device). According to some embodiments, the unique identifier might include, without limitation, a bar code, a quick response (“QR”) code, a radio frequency identifier (“rfid”) tag, or an intelligence enabled things (“IET”) tag (as described in detail in the '918 application, which has already been incorporated herein by reference in its entirety for all purposes), and/or the like.

System 100 might further comprise one or more vehicles 160a-160n (collectively, “vehicles 160” or the like) that a user 110 may use during the course of performing the one or more tasks. In some embodiments, system 100 might further comprise one or more weather information sources 165 that may provide weather information that the computing system 115 might use when assigning or modifying tasks.

The lightning bolt symbols as shown in FIG. 1 are used to denote wireless communications between the one or more telecommunications relay systems 130 and each user device 105, between the one or more telecommunications relay systems 130 and each equipment 135 that is configured to enable wireless communications (that are located at location(s) 140, storage location(s) 145, in vehicle 160, or at some other location, or the like), between the one or more telecommunications relay systems 130 and each inventory system 150 at particular storage locations 145, between the one or more telecommunications relay systems 130 and each tracking device(s) that is used to track equipment 135, and between the one or more telecommunications relay systems 130 and each vehicle 160, and/or the like.

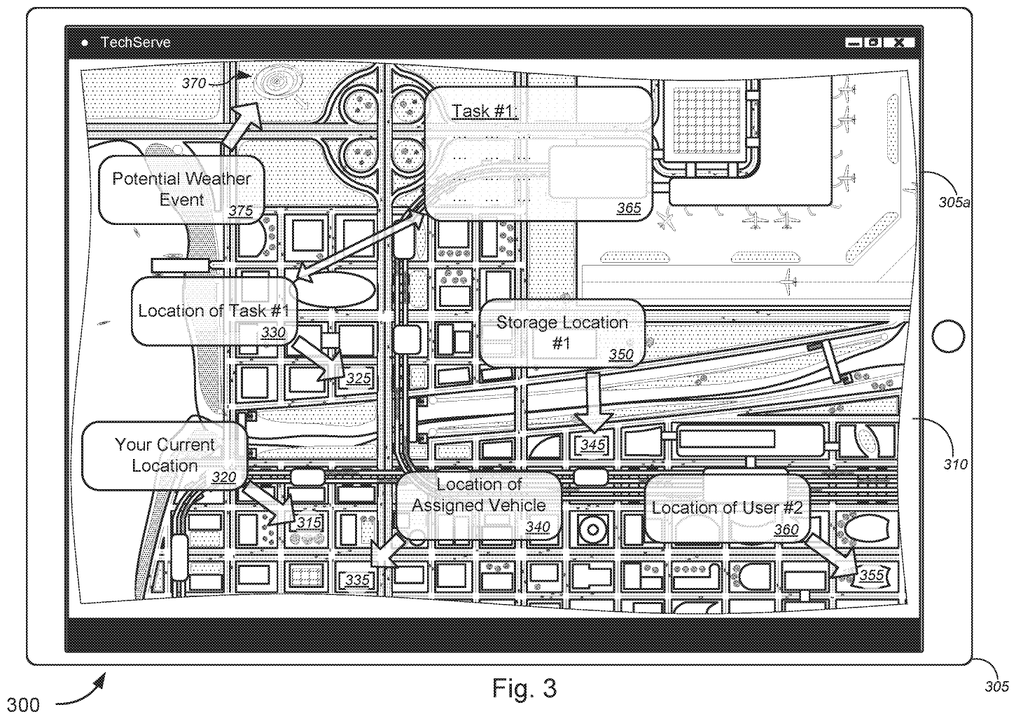

In operation, computing system 115 might receive, from a user device 105a associated with a first user 110a, a first request for information regarding a first task; might determine a current location of the user device 105a associated with the first user 110a; might access one or more first databases 120 to obtain information regarding the first task, in response to receiving the first request; and might compile the information regarding the first task that is obtained from the one or more first databases 120. Computing system 115 might identify one or more first equipment 135 necessary for completing the first task, based at least in part on the compiled information regarding the first task; might identify one or more first locations 140a-140n for performing the first task, based at least in part on the compiled information regarding the first task; and might identify one or more first storage locations 145a-145n that have adequate supplies of the identified one or more first equipment 135 and that are within a predetermined distance from one of the current location of the user device 105a associated with the first user 110a or at least one first location among the one or more first locations 140a-140n, based at least in part on the compiled information regarding the first task. Computing system 115 might generate and display, on the user device 105a associated with the first user 110a, one or more user interface screens, the one or more user interface screens displaying the compiled information regarding the first task and displaying a map view (an example of which is shown in FIG. 3, or the like) depicting at least one of the identified one or more first locations 140a-140n, the identified one or more first storage locations 145a-145n, or the current location of the user device 105a associated with the first user 110a, and/or the like. In some cases, displaying the compiled information regarding the first task might comprise displaying detailed information regarding each of the identified one or more first equipment, the detailed information comprising at least one of part category, model number, serial number, brief description, a schematic diagram of the first equipment or a photograph of the first equipment, and/or the like.

In some embodiments, computing system might identify one or more second users 110b-110n who are capable of assisting the first user 110a in performance of the first task or performance of one or more second tasks that are related to performance of the first task, based at least in part on the compiled information regarding the first task; might identify a current location for each of the identified one or more second users 110b-110n, based at least in part on the compiled information regarding the first task; might access, from a second database 120, contact information for each of the identified one or more second users 110b-110n; and might provide, through at least one user interface screen of the generated one or more user interface screens, an option to contact each of at least one second user among the one or more identified one or more second users, based on contact information for the at least one second user 110b-110n. In such cases, the one or more user interface screens further display at least one of information regarding the at least one second user 110b-110n and a map view depicting a current location of each of the at least one second user 110b-110n.

According to some embodiments, the identified one or more second users 110b-110n might include, without limitation, at least one of a technician who is qualified to work on the first task, a technician who is qualified to operate at least one of the identified one or more first equipment, an expert on use of at least one of the identified one or more first equipment, a user familiar with ordering more of at least one of the identified one or more first equipment, a technician familiar with working at one or more of the identified one or more first locations, a user familiar with at least one of the identified one or more first storage locations, or a sales representative for handling sales-related questions arising during the first task, and/or the like. In some cases, providing the option to contact each of the at least one second user might include, but is not limited to, at least one of providing an option to contact each of the at least one second user via telephone, providing an option to contact each of the at least one second user via e-mail, providing an option to contact each of the at least one second user via a short message service (“SMS”) message, providing an option to contact each of the at least one second user via instant messaging, providing an option to contact at least two of the one or more second users via group messaging, or providing an option to contact at least two of the one or more second users via broadcast messaging, and/or the like.

In some embodiments, computing system 115 might identify one or more first vehicles 160a-160n that are at least one of suitable for performing the first task or suitable for transporting the identified one or more first equipment 135 and that are within a predetermined distance from the current location of the user device 105a associated with the first user 110a, based at least in part on the compiled information regarding the first task. In such cases, the one or more user interface screens might further display at least one of information regarding at least one of the identified one or more first vehicles 160a-160n and a map view depicting a location of each of the identified one or more first vehicles 160a-160n relative to the current location of the user device 105a associated with the first user 110a. In some instances, computing system 115 might assign a first vehicle 160a to the first user 110a from among the identified one or more first vehicles 160a-160n. In some cases, computing system 115 might generate an itinerary for the first user 110a, the itinerary comprising mapped routes from one to another of the current location of the user device 105a associated with the first user 110a, a location of the assigned first vehicle 160a, at least one of the identified one or more first storage locations 145a-145n for pickup of the identified one or more first equipment 135, and each of the identified one or more first locations 140a-140n for completing the first task.

According to some embodiments, computing system 115 might track locations of each of the identified one or more first equipment 135 and/or might track locations of each of the identified one or more first vehicles 160. In some instances, each first equipment 135 among the identified one or more first equipment might comprise an equipment tag having a unique first identifier associated with said first equipment 135. Similarly, each first vehicle 160 among the identified one or more first vehicles might comprise a vehicle tag having a unique second identifier associated with said first vehicle. Here, the equipment tag and the vehicle tag might include, without limitation, a tag affixed with a bar code, a tag affixed with a quick response (“QR”) code, a radio frequency identifier (“rfid”) tag, or an intelligence enabled things (“IET”) tag (as described in detail in the '918 application, which has already been incorporated herein by reference in its entirety for all purposes), and/or the like. In such cases, tracking locations of each of the identified one or more first equipment might comprise at least one of using a scanner 155 at one or more locations 140 to scan the unique first identifier associated with each first equipment 135 when said first equipment 135 arrives at each location 140 or using a location tracking device 155 (or equipment tag) disposed on each first equipment 135. Likewise, tracking locations of each of the identified one or more first vehicles 160 comprises at least one of using a scanner 155 at one or more locations 140 to scan the unique second identifier associated with each first vehicle 160 when said first vehicle 160 arrives at each location 140 or using a location tracking device 155 (or vehicle tag) disposed on each first vehicle 160.

Merely by way of example, in some cases, computing system 115 might monitor, based on one or more weather information sources 165, current and impending weather conditions around each of at least one of the current location of the user device 105a associated with the first user 110a, the identified one or more first locations 140a-140n for performing the first task, the identified one or more first storage locations 145a-145n, or one or more routes between two or more locations among the at least one of the current location of the user device 105a associated with the first user 110a, the identified one or more first locations 140a-140n for performing the first task, the identified one or more first storage locations 145a-145n, and/or the like; might determine whether the monitored current and impending weather conditions would have an impact on performance of the first task; and based on a determination that the monitored current and impending weather conditions exceeds a predetermined probability of impacting performance of the first task, might generate and display, on the user device 105a associated with the first user 110a, at least one of one or more weather alerts, one or more changes to the first task, or one or more updated user interface screens highlighting changes due to the monitored current and impending weather conditions, and/or the like.

According to some embodiments, computing system 115 might generate and display, on one or more display devices, one or more group interface screens (not shown) to enable one or more third users 110 to access the compiled information regarding the first task and the map view depicting the at least one of the identified one or more first locations, the identified one or more first storage locations, or the current location of the user device associated with the first user, the one or more third users comprising each of the at least one of a manager or one or more group members tasked with performing the first task.

In some aspects, the system might provide field technicians the ability to see their nearest co-workers and/or material storage locations, and to find the equipment needed to complete a task(s). The system tracks vehicles at a technician level, while tracking inventory at a vehicle level, and tracking inventory at a job or task level, while providing the technician(s) with visibility to available inventory or equipment. The system, in some instances, may be applicable to the following scenarios (although not limited to these): (a) a customer requests changes while a technician is on site (which might involve upgrades or upsells, which may be better handled by another person (e.g., a sales representative or the like) that the system might link the technician to via SMS, text, e-mail, telephone call, etc.); (b) technicians unfamiliar with a particular task, a particular piece of equipment, or a particular work location, or the like might put in contact with another technician who is familiar with at least one of these (and might allow such other technician to be assigned to the task; (c) severe weather events (or other natural or man-made events or the like) might necessitate modification of the task, the use of additional equipment, the use of other types of vehicles, the help of other users or technicians, and/or the modification of timelines, or the like, which the system is fully capable of assigning or changing, etc.; and/or the like.

In this manner, the system and method can track and coordinate amongst at least one of one or more users or technicians, one or more vehicles, one or more inventory equipment or other equipment, and/or one or more locations at which tasks are to be performed, and/or the like. Some non-limiting benefits or advantages of the system might include, but is not limited to, optimized workflow, etc., and use of the system can result in reduced inventory costs, increased productivity, improved efficiency, and/or fewer missed commitments, and/or the like.

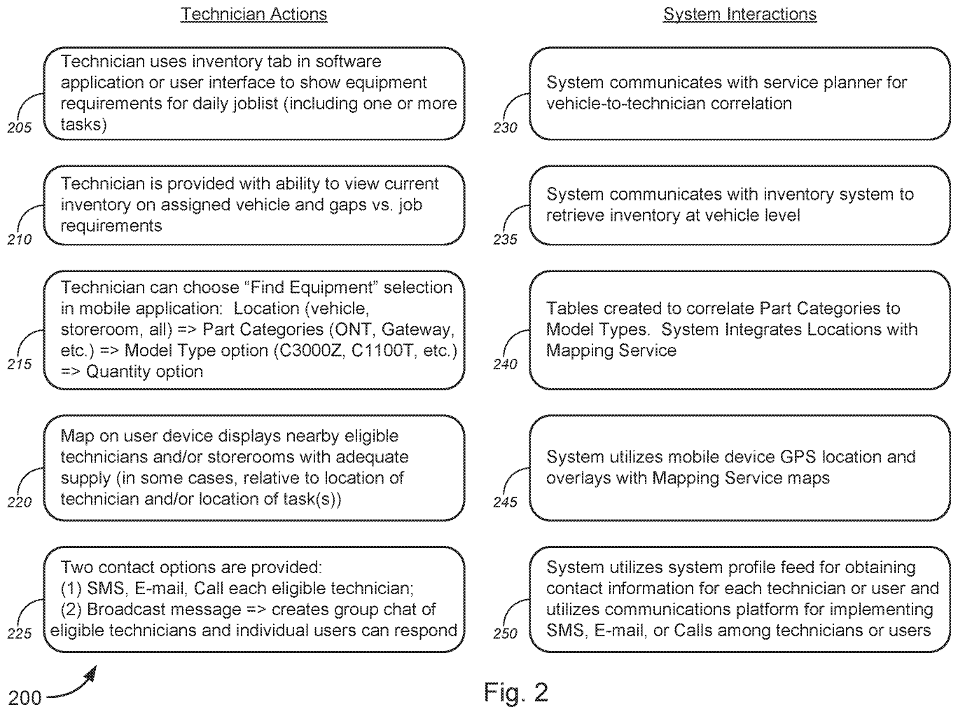

These and other functions of the system 100 (and its components) are described in greater detail below with respect to FIGS. 2-4.

FIG. 2 is a schematic diagram illustrating a non-limiting example 200 of technician actions and system interactions when implementing tracking of and coordination among technicians, vehicles, and inventory, in accordance with various embodiments.

With reference to the non-limiting example 200 of FIG. 2, the technician or user actions might include the following: the technician or user uses the inventory tab in the software application (“app”) or user interface (“UI”) to show equipment requirements for daily joblist (including one or more tasks to be performed by the technician or user) (block 205); the technician or user is provided with the ability or capability to view current inventory on assigned vehicle as well as any gaps vs. job requirements (block 210); the technician or user can choose “Find Equipment” selection in the mobile app: Location (e.g., vehicle, storeroom, all), Part Categories (e.g., optical network terminal (“ONT”), gateway, etc.), Model Type option (e.g., C3000Z, C1100T, etc.), quantity option (e.g., the available number of the equipment at a particular location(s), etc.) (block 215); the technician or user may be provided with a map on the user device that displays nearby eligible technicians and/or storerooms with adequate supply of the inventory or equipment (in some cases, relative to the location of the technician or user and/or location of the task(s)) (block 220); and the technician or user may be provided with two contact options: (1) contacting each eligible technician via at least one of short message service (“SMS”) message, instant messaging, e-mail, and/or telephone call, or (2) contacting at least two of the eligible technicians via group messaging and/or broadcast messaging (in which individual technicians or users can respond (block 225).

The corresponding system interactions might include the following: the system might communicate with a service planner system for vehicle-to-technician correlation (block 230); the system might communicate with the inventory system to retrieve inventory at the vehicle level (block 235); the system might create tables to correlate Part Categories to Model Types and might integrate locations with a mapping service (block 240); the system might utilize mobile device global positioning system (“GPS”) location and might overlay with mapping service maps (block 245); and the system might utilize system profile feed for obtaining contact information for each technician or user and might utilize a communications platform for implementing the communications among the technicians or users (block 250).

These and other features of the example 200 are described in greater detail below with respect to FIGS. 1, 3, and 4.

FIG. 3 is a schematic diagram illustrating a non-limiting example 300 of user device depicting a geographic area in which tracking of and coordination among technicians, vehicles, and inventory may be implemented, along with display of example information fields, in accordance with various embodiments.

With reference to the non-limiting example 300 of FIG. 3, a user device 305 is provided. The user device 305 might comprise a display screen 305a on which a software application 310 (“app”; in this case, the “TechServe app” or the like) is running. The TechServe app 310 might display a map of a geographical area (in this case, a portion of a city; although the various embodiments are not limited to a city or a portion of a city, and any suitable geographical location may be displayed in map form for the purposes of implementing the tracking and coordinating functionalities according to the various embodiments). The TechServe app 310 might further generate and display one or more overlays, including, but not limited to, a marker 315 denoting a current location of the user associated with the user device 305 within the geographical area, a message field or bubble 320 indicating the user's current location at marker 315 (with appropriate arrow or other graphics or icons), a marker 325 denoting a location of a first task within the geographical area, a message field or bubble 330 indicating the location of the first task at marker 325 (with appropriate arrow or other graphics or icons), a marker 335 denoting a location of an assigned vehicle within the geographical area, a message field or bubble 340 indicating the location of the assigned vehicle at marker 335 (with appropriate arrow or other graphics or icons), a marker 345 denoting a first storage location (at which is stored equipment for performing the first task) within the geographical area, a message field or bubble 350 indicating the first storage location at marker 345 (with appropriate arrow or other graphics or icons), a marker 355 denoting a current location of a second user or technician (who is qualified to aid the user in performing the first task) within the geographical area, a message field or bubble 360 indicating the current location of the second user or technician at marker 355 (with appropriate arrow or other graphics or icons), a message field or bubble 365 providing detailed information regarding the first task, a marker 370 denoting a current location of a potential weather event (which may affect performance of the first task; in this case, a tornado, although the various embodiments are not limited to such, and the weather (or other natural or man-made) events or conditions may include, without limitation, a thunder storm, a blizzard, heavy rains, sleet, hail, flooding, dust storms, earthquake, hurricanes, tsunamis, etc.) within the geographical area, a message field or bubble 375 indicating the current location of the potential weather event at marker 370 (with appropriate arrow or other graphics or icons), and/or the like.

These and other features of the example 300 are described in greater detail below with respect to FIGS. 1, 2, and 4.

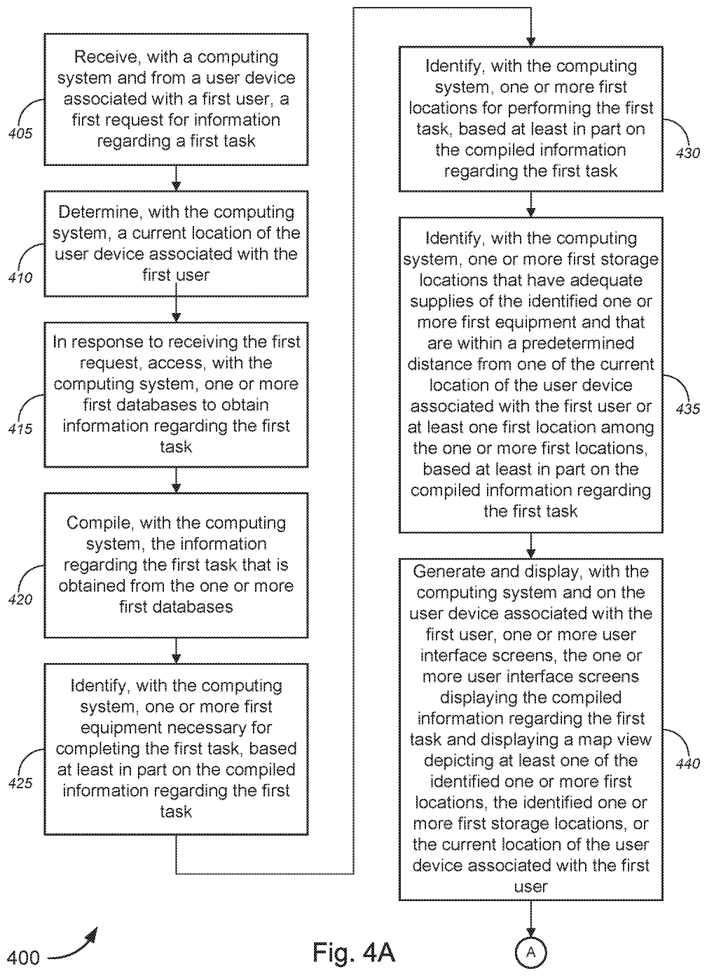

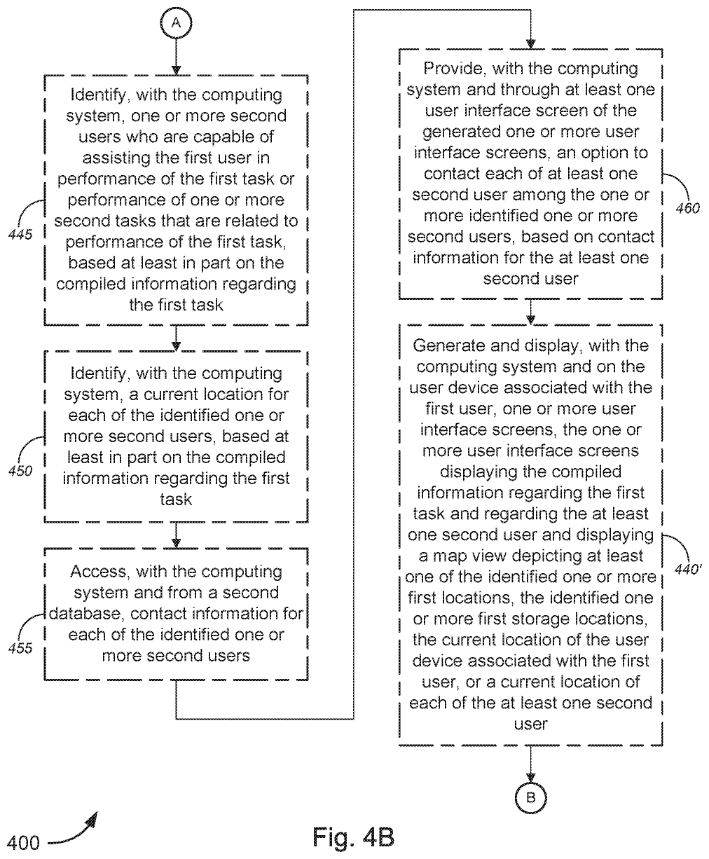

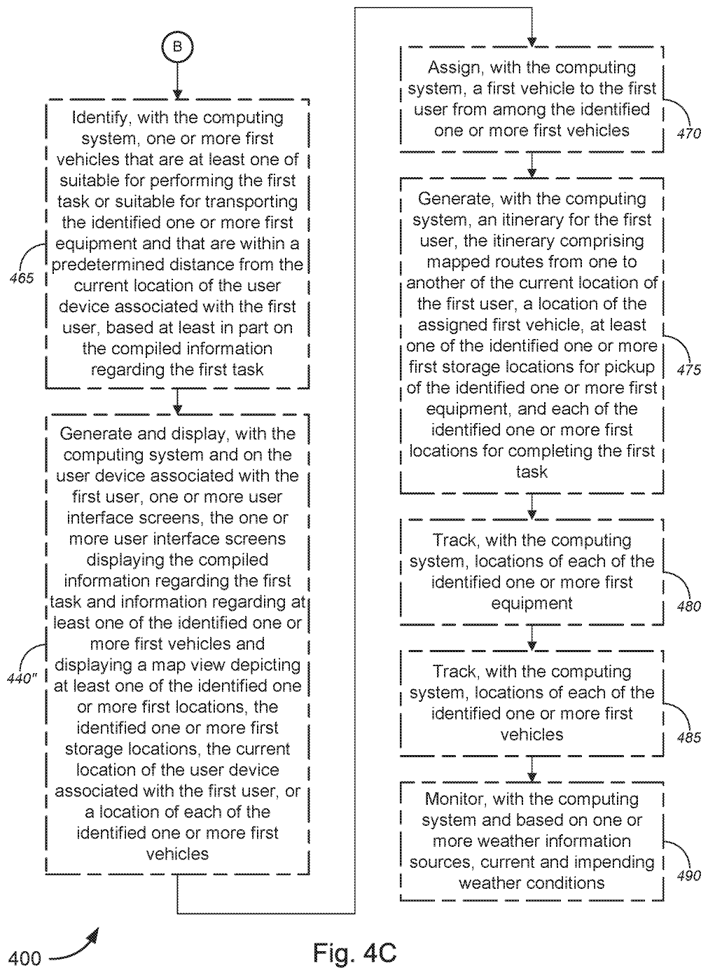

FIGS. 4A-4C (collectively, “FIG. 4”) are flow diagrams illustrating a method 400 for implementing tracking of and coordination among technicians, vehicles, and inventory, in accordance with various embodiments. Method 400 of FIG. 4A continues onto FIG. 4B following the circular marker denoted, “A,” and continues from FIG. 4B onto FIG. 4C following the circular marker denoted, “B.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the method 400 illustrated by FIG. 4 (e.g., by executing instructions embodied on a computer readable medium), the systems, examples, or embodiments 100, 200, and 300 of FIGS. 1, 2, and 3 can each also operate according to other modes of operation and/or perform other suitable procedures.

In the non-limiting embodiment of FIG. 4A, method 400, at block 405, might comprise receiving, with a computing system and from a user device associated with a first user, a first request for information regarding a first task. In some embodiments, the computing system might include, without limitation, one of a processor of the user device running a software application (“app”), a workflow control system, a workflow coordination system, a server computer over a network, a cloud-based computing system over a network, or a distributed computing system, and/or the like. In some cases, the user device might include, but is not limited to, at least one of a tablet computer, a laptop computer, a smart phone, or a mobile phone, and/or the like.

At block 410, method 400 might comprise determining, with the computing system, a current location of the user device associated with the first user. Method 400 might further comprise, in response to receiving the first request, accessing, with the computing system, one or more first databases to obtain information regarding the first task (block 415). Method 400 might further comprise, at block 420, compiling, with the computing system, the information regarding the first task that is obtained from the one or more first databases.

Method 400 might further comprise identifying, with the computing system, one or more first equipment necessary for completing the first task, based at least in part on the compiled information regarding the first task (block 425); identifying, with the computing system, one or more first locations for performing the first task, based at least in part on the compiled information regarding the first task (block 430); and identifying, with the computing system, one or more first storage locations that have adequate supplies of the identified one or more first equipment and that are within a predetermined distance from one of the current location of the user device associated with the first user or at least one first location among the one or more first locations, based at least in part on the compiled information regarding the first task (block 435).

At block 440, method 400 might comprise generating and displaying, with the computing system and on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user, and/or the like. According to some embodiments, displaying the compiled information regarding the first task might comprise displaying detailed information regarding each of the identified one or more first equipment, the detailed information comprising at least one of part category, model number, serial number, brief description, a schematic diagram of the first equipment or a photograph of the first equipment, and/or the like. Method 400 might continue onto the process at optional block 445 in FIG. 4B following the circular marker denoted, “A.”

At optional block 445 in FIG. 4B (following the circular marker denoted, “A”), method 400 might comprise identifying, with the computing system, one or more second users who are capable of assisting the first user in performance of the first task or performance of one or more second tasks that are related to performance of the first task, based at least in part on the compiled information regarding the first task. Method 400 might further comprise identifying, with the computing system, a current location for each of the identified one or more second users, based at least in part on the compiled information regarding the first task (optional block 450); accessing, with the computing system and from a second database, contact information for each of the identified one or more second users (at optional block 455); and providing, with the computing system and through at least one user interface screen of the generated one or more user interface screens, an option to contact each of at least one second user among the one or more identified one or more second users, based on contact information for the at least one second user (at optional block 455). At optional block 440′, method 400 might comprise generating and displaying, with the computing system and on the user device associated with the first user, one or more user interface screens, the one or more user interface screens displaying the compiled information regarding the first task and information regarding the at least one second user and displaying a map view depicting at least one of the identified one or more first locations, the identified one or more first storage locations, the current location of the user device associated with the first user, or a current location of each of the at least one second user, and/or the like.

In some embodiments, the identified one or more second users might include, without limitation, at least one of a technician who is qualified to work on the first task, a technician who is qualified to operate at least one of the identified one or more first equipment, an expert on use of at least one of the identified one or more first equipment, a user familiar with ordering more of at least one of the identified one or more first equipment, a technician familiar with working at one or more of the identified one or more first locations, a user familiar with at least one of the identified one or more first storage locations, or a sales representative for handling sales-related questions arising during the first task, and/or the like. In some cases, providing the option to contact each of the at least one second user might comprise at least one of providing an option to contact each of the at least one second user via telephone, providing an option to contact each of the at least one second user via e-mail, providing an option to contact each of the at least one second user via a short message service (“SMS”) message, providing an option to contact each of the at least one second user via instant messaging, providing an option to contact at least two of the one or more second users via group messaging, or providing an option to contact at least two of the one or more second users via broadcast messaging, and/or the like. Method 400 might continue onto the process at optional block 465 in FIG. 4C following the circular marker denoted, “B.”

At optional block 465 in FIG. 4C (following the circular marker denoted, “B”), method 400 might comprise identifying, with the computing system, one or more first vehicles that are at least one of suitable for performing the first task or suitable for transporting the identified one or more first equipment and that are within a predetermined distance from the current location of the user device associated with the first user, based at least in part on the compiled information regarding the first task. Method 400 might further comprise, at optional block 440″, generating and displaying, with the computing system and on the user device associated with the first user, one or more user interface screens, the one or more user interface screens displaying the compiled information regarding the first task and information regarding at least one of the identified one or more first vehicles and displaying a map view depicting at least one of the identified one or more first locations, the identified one or more first storage locations, the current location of the user device associated with the first user, or a location of each of the identified one or more first vehicles relative to the current location of the user device associated with the first user, and/or the like.

Method 400 might further comprise assigning, with the computing system, a first vehicle to the first user from among the identified one or more first vehicles (optional block 470). At optional block 475, method 400 might comprise generating, with the computing system, an itinerary for the first user, the itinerary comprising mapped routes from one to another of the current location of the user device associated with the first user, a location of the assigned first vehicle, at least one of the identified one or more first storage locations for pickup of the identified one or more first equipment, and each of the identified one or more first locations for completing the first task.

Method 400 might further comprise tracking, with the computing system, locations of each of the identified one or more first equipment (optional block 480) and/or tracking, with the computing system, locations of each of the identified one or more first vehicles (optional block 485). In some cases, each first equipment among the identified one or more first equipment might comprises an equipment tag having a unique first identifier associated with said first equipment. In some instances, each first vehicle among the identified one or more first vehicles might comprise a vehicle tag having a unique second identifier associated with said first vehicle. In some cases, tracking locations of each of the identified one or more first equipment might comprise at least one of using a scanner at one or more locations to scan the unique first identifier associated with each first equipment when said first equipment arrives at each location or using a location tracking device disposed on each first equipment, and/or the like. In some instances, tracking locations of each of the identified one or more first vehicles might comprise at least one of using a scanner at one or more locations to scan the unique second identifier associated with each first vehicle when said first vehicle arrives at each location or using a location tracking device disposed on each first vehicle, and/or the like.

According to some embodiments, method 400, at optional block 490, might comprise monitoring, with the computing system and based on one or more weather information sources, current and impending weather conditions around each of at least one of the current location of the user device associated with the first user, the identified one or more first locations for performing the first task, the identified one or more first storage locations, or one or more routes between two or more locations among the at least one of the current location of the user device associated with the first user, the identified one or more first locations for performing the first task, the identified one or more first storage locations. In some cases, the computing system might determine whether the monitored current and impending weather conditions would have an impact on performance of the first task, and based on a determination that the monitored current and impending weather conditions exceeds a predetermined probability of impacting performance of the first task (not shown in FIG. 4), and might generate and display, on the user device associated with the first user, at least one of one or more weather alerts, one or more changes to the first task, or one or more updated user interface screens highlighting changes due to the monitored current and impending weather conditions, and/or the like (not shown in FIG. 4).

In some cases, although not shown in FIG. 4, the method might further comprise generating and displaying, with the computing system and on one or more display devices, one or more group interface screens to enable one or more third users to access the compiled information regarding the first task and the map view depicting the at least one of the identified one or more first locations, the identified one or more first storage locations, or the current location of the user device associated with the first user, the one or more third users comprising each of the at least one of a manager or one or more group members tasked with performing the first task.

Exemplary System and Hardware Implementation

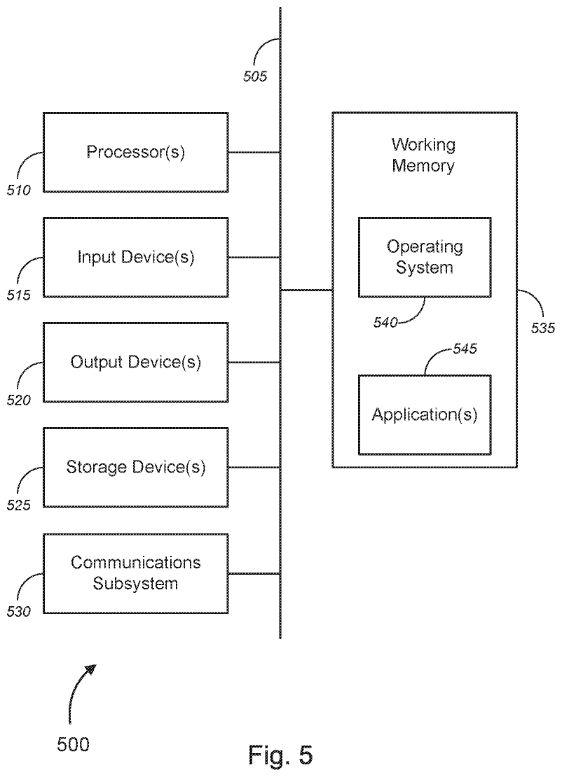

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., user devices 105a-105n, computing system 105, and tracking devices 155, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., user devices 105a-105n, computing system 105, and tracking devices 155, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

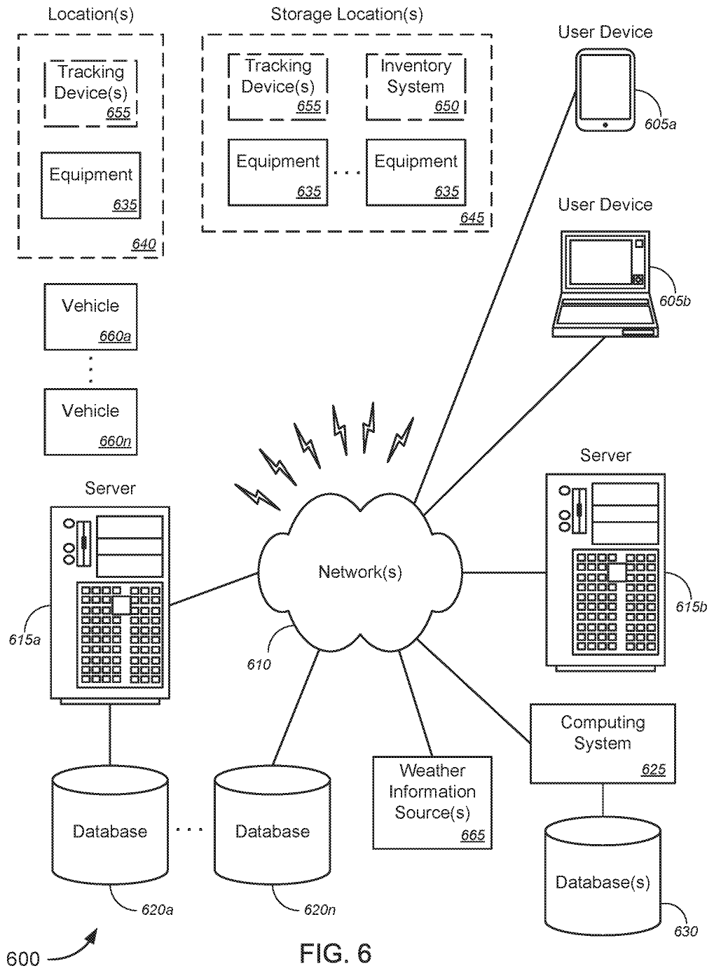

As noted above, a set of embodiments comprises methods and systems for implementing logistical coordination, and, more particularly, to methods, systems, and apparatuses for implementing tracking of and coordination among technicians, vehicles, and inventory. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 (similar to network(s) 125 FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing logistical coordination, and, more particularly, to methods, systems, and apparatuses for implementing tracking of and coordination among technicians, vehicles, and inventory, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a computing system 625 (similar to computing system 115 of FIG. 1, or the like) and corresponding database(s) 630 (similar to database(s) 120 of FIG. 1, or the like), equipment 635 (similar to equipment 135 of FIG. 1, or the like), one or more locations 640 (similar to location(s) 140a-140n of FIG. 1, or the like) at which one or more first tasks are to be performed, one or more storage locations 645 (similar to storage location(s) 145a-145n of FIG. 1, or the like) at which equipment 635 may be stored when not in use, an inventory system 650 (optional; similar to inventory systems 150 of FIG. 1, or the like) that tracks items or inventory stored at each of at least one storage location 645, one or more tracking devices 655 (similar to tracking devices 155 of FIG. 1, or the like) that are used to track the location of equipment 635 and/or vehicles 660, and one or more vehicles 660a-660n (similar to vehicles 160a-160n of FIG. 1, or the like), and one or more weather information sources 665 (similar to weather information sources 165 of FIG. 1, or the like).

In operation, computing system 625 might receive, from a user device 605a associated with a first user, a first request for information regarding a first task; might determine a current location of the user device 605a associated with the first user; might access one or more first databases 620 to obtain information regarding the first task, in response to receiving the first request; and might compile the information regarding the first task that is obtained from the one or more first databases 620. Computing system 625 might identify one or more first equipment 635 necessary for completing the first task, based at least in part on the compiled information regarding the first task; might identify one or more first locations 640 for performing the first task, based at least in part on the compiled information regarding the first task; and might identify one or more first storage locations 645 that have adequate supplies of the identified one or more first equipment 635 and that are within a predetermined distance from one of the current location of the user device 605a associated with the first user or at least one first location among the one or more first locations 640, based at least in part on the compiled information regarding the first task. Computing system 625 might generate and display, on the user device 605a associated with the first user, one or more user interface screens, the one or more user interface screens displaying the compiled information regarding the first task and displaying a map view (an example of which is shown in FIG. 3, or the like) depicting at least one of the identified one or more first locations 640, the identified one or more first storage locations 645, or the current location of the user device 605a associated with the first user, and/or the like. In some cases, displaying the compiled information regarding the first task might comprise displaying detailed information regarding each of the identified one or more first equipment, the detailed information comprising at least one of part category, model number, serial number, brief description, a schematic diagram of the first equipment or a photograph of the first equipment, and/or the like.

In some embodiments, computing system might identify one or more second users who are capable of assisting the first user in performance of the first task or performance of one or more second tasks that are related to performance of the first task, based at least in part on the compiled information regarding the first task; might identify a current location for each of the identified one or more second users, based at least in part on the compiled information regarding the first task; might access, from a second database 620, contact information for each of the identified one or more second users; and might provide, through at least one user interface screen of the generated one or more user interface screens, an option to contact each of at least one second user among the one or more identified one or more second users, based on contact information for the at least one second user. In such cases, the one or more user interface screens further display at least one of information regarding the at least one second user and a map view depicting a current location of each of the at least one second user.

According to some embodiments, the identified one or more second users might include, without limitation, at least one of a technician who is qualified to work on the first task, a technician who is qualified to operate at least one of the identified one or more first equipment, an expert on use of at least one of the identified one or more first equipment, a user familiar with ordering more of at least one of the identified one or more first equipment, a technician familiar with working at one or more of the identified one or more first locations, a user familiar with at least one of the identified one or more first storage locations, or a sales representative for handling sales-related questions arising during the first task, and/or the like. In some cases, providing the option to contact each of the at least one second user might include, but is not limited to, at least one of providing an option to contact each of the at least one second user via telephone, providing an option to contact each of the at least one second user via e-mail, providing an option to contact each of the at least one second user via a short message service (“SMS”) message, providing an option to contact each of the at least one second user via instant messaging, providing an option to contact at least two of the one or more second users via group messaging, or providing an option to contact at least two of the one or more second users via broadcast messaging, and/or the like.

In some embodiments, computing system 625 might identify one or more first vehicles 660a-660n that are at least one of suitable for performing the first task or suitable for transporting the identified one or more first equipment 635 and that are within a predetermined distance from the current location of the user device 605a associated with the first user, based at least in part on the compiled information regarding the first task. In such cases, the one or more user interface screens might further display at least one of information regarding at least one of the identified one or more first vehicles 660a-660n and a map view depicting a location of each of the identified one or more first vehicles 660a-660n relative to the current location of the user device 605a associated with the first user. In some instances, computing system 625 might assign a first vehicle 660a to the first user from among the identified one or more first vehicles 660a-660n. In some cases, computing system 625 might generate an itinerary for the first user, the itinerary comprising mapped routes from one to another of the current location of the user device 605a associated with the first user, a location of the assigned first vehicle 660a, at least one of the identified one or more first storage locations 645 for pickup of the identified one or more first equipment 635, and each of the identified one or more first locations 640 for completing the first task.

According to some embodiments, computing system 625 might track locations of each of the identified one or more first equipment 635 and/or might track locations of each of the identified one or more first vehicles 660. In some instances, each first equipment 635 among the identified one or more first equipment might comprise an equipment tag having a unique first identifier associated with said first equipment 635. Similarly, each first vehicle 660 among the identified one or more first vehicles might comprise a vehicle tag having a unique second identifier associated with said first vehicle. Here, the equipment tag and the vehicle tag might include, without limitation, a tag affixed with a bar code, a tag affixed with a quick response (“QR”) code, a radio frequency identifier (“rfid”) tag, or an intelligence enabled things (“IET”) tag (as described in detail in the '918 application, which has already been incorporated herein by reference in its entirety for all purposes), and/or the like. In such cases, tracking locations of each of the identified one or more first equipment might comprise at least one of using a scanner 655 at one or more locations 640 to scan the unique first identifier associated with each first equipment 635 when said first equipment 635 arrives at each location 640 or using a location tracking device 655 (or equipment tag) disposed on each first equipment 635. Likewise, tracking locations of each of the identified one or more first vehicles 660 comprises at least one of using a scanner 655 at one or more locations 640 to scan the unique second identifier associated with each first vehicle 660 when said first vehicle 660 arrives at each location 640 or using a location tracking device 655 (or vehicle tag) disposed on each first vehicle 660.

Merely by way of example, in some cases, computing system 625 might monitor, based on one or more weather information sources 665, current and impending weather conditions around each of at least one of the current location of the user device 605a associated with the first user, the identified one or more first locations 640 for performing the first task, the identified one or more first storage locations 645, or one or more routes between two or more locations among the at least one of the current location of the user device 605a associated with the first user, the identified one or more first locations 640 for performing the first task, the identified one or more first storage locations 645, and/or the like; might determine whether the monitored current and impending weather conditions would have an impact on performance of the first task; and based on a determination that the monitored current and impending weather conditions exceeds a predetermined probability of impacting performance of the first task, might generate and display, on the user device 605a associated with the first user, at least one of one or more weather alerts, one or more changes to the first task, or one or more updated user interface screens highlighting changes due to the monitored current and impending weather conditions, and/or the like.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computing system and from a user device associated with a first user, a first request for information regarding a first task;
determining, with the computing system, a current location of the user device associated with the first user;
in response to receiving the first request, accessing, with the computing system, one or more first databases to obtain information regarding the first task;
compiling, with the computing system, the information regarding the first task that is obtained from the one or more first databases;
identifying, with the computing system, one or more first equipment necessary for completing the first task, based at least in part on the compiled information regarding the first task;
identifying, with the computing system, one or more first locations for performing the first task, based at least in part on the compiled information regarding the first task;
identifying, with the computing system, one or more first storage locations that have adequate supplies of the identified one or more first equipment and that are within a predetermined distance from one of the current location of the user device associated with the first user or at least one first location among the one or more first locations, based at least in part on the compiled information regarding the first task; and
generating and displaying, with the computing system and on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user.

2. The method of claim 1, wherein the computing system comprises one of a processor of the user device running a software application (“app”), a workflow control system, a workflow coordination system, a server computer over a network, a cloud-based computing system over a network, or a distributed computing system.

3. The method of claim 1, wherein the user device comprises at least one of a tablet computer, a laptop computer, a smart phone, or a mobile phone.

4. The method of claim 1, further comprising:
identifying, with the computing system, one or more second users who are capable of assisting the first user in performance of the first task or performance of one or more second tasks that are related to performance of the first task, based at least in part on the compiled information regarding the first task;
identifying, with the computing system, a current location for each of the identified one or more second users, based at least in part on the compiled information regarding the first task;
accessing, with the computing system and from a second database, contact information for each of the identified one or more second users; and
providing, with the computing system and through at least one user interface screen of the generated one or more user interface screens, an option to contact each of at least one second user among the one or more identified one or more second users, based on contact information for the at least one second user;
wherein the one or more user interface screens further display at least one of information regarding the at least one second user and a map view depicting a current location of each of the at least one second user.

5. The method of claim 4, wherein the identified one or more second users comprises at least one of a technician who is qualified to work on the first task, a technician who is qualified to operate at least one of the identified one or more first equipment, an expert on use of at least one of the identified one or more first equipment, a user familiar with ordering more of at least one of the identified one or more first equipment, a technician familiar with working at one or more of the identified one or more first locations, a user familiar with at least one of the identified one or more first storage locations, or a sales representative for handling sales-related questions arising during the first task.

6. The method of claim 4, wherein providing the option to contact each of the at least one second user comprises at least one of providing an option to contact each of the at least one second user via telephone, providing an option to contact each of the at least one second user via e-mail, providing an option to contact each of the at least one second user via a short message service (“SMS”) message, providing an option to contact each of the at least one second user via instant messaging, providing an option to contact at least two of the one or more second users via group messaging, or providing an option to contact at least two of the one or more second users via broadcast messaging.

7. The method of claim 1, wherein displaying the compiled information regarding the first task comprises displaying detailed information regarding each of the identified one or more first equipment, the detailed information comprising at least one of part category, model number, serial number, brief description, a schematic diagram of the first equipment or a photograph of the first equipment.

8. The method of claim 1, further comprising:
identifying, with the computing system, one or more first vehicles that are at least one of suitable for performing the first task or suitable for transporting the identified one or more first equipment and that are within a predetermined distance from the current location of the user device associated with the first user, based at least in part on the compiled information regarding the first task;
wherein the one or more user interface screens further display at least one of information regarding at least one of the identified one or more first vehicles and a map view depicting a location of each of the identified one or more first vehicles relative to the current location of the user device associated with the first user.

9. The method of claim 8, further comprising:
assigning, with the computing system, a first vehicle to the first user from among the identified one or more first vehicles.

10. The method of claim 9, further comprising:
generating, with the computing system, an itinerary for the first user, the itinerary comprising mapped routes from one to another of the current location of the user device associated with the first user, a location of the assigned first vehicle, at least one of the identified one or more first storage locations for pickup of the identified one or more first equipment, and each of the identified one or more first locations for completing the first task.

11. The method of claim 8, further comprising at least one of:
tracking, with the computing system, locations of each of the identified one or more first equipment; or
tracking, with the computing system, locations of each of the identified one or more first vehicles.

12. The method of claim 11, wherein each first equipment among the identified one or more first equipment comprises an equipment tag having a unique first identifier associated with said first equipment, wherein each first vehicle among the identified one or more first vehicles comprises a vehicle tag having a unique second identifier associated with said first vehicle, wherein tracking locations of each of the identified one or more first equipment comprise at least one of using a scanner at one or more locations to scan the unique first identifier associated with each first equipment when said first equipment arrives at each location or using a location tracking device disposed on each first equipment, wherein tracking locations of each of the identified one or more first vehicles comprises at least one of using a scanner at one or more locations to scan the unique second identifier associated with each first vehicle when said first vehicle arrives at each location or using a location tracking device disposed on each first vehicle.

13. The method of claim 1, further comprising:
monitoring, with the computing system and based on one or more weather information sources, current and impending weather conditions around each of at least one of the current location of the user device associated with the first user, the identified one or more first locations for performing the first task, the identified one or more first storage locations, or one or more routes between two or more locations among the at least one of the current location of the user device associated with the first user, the identified one or more first locations for performing the first task, the identified one or more first storage locations;
determining, with the computing system, whether the monitored current and impending weather conditions would have an impact on performance of the first task; and
based on a determination that the monitored current and impending weather conditions exceeds a predetermined probability of impacting performance of the first task, generating and displaying, with the computing system and on the user device associated with the first user, at least one of one or more weather alerts, one or more changes to the first task, or one or more updated user interface screens highlighting changes due to the monitored current and impending weather conditions.

14. The method of claim 1, further comprising:
generating and displaying, with the computing system and on one or more display devices, one or more group interface screens to enable one or more third users to access the compiled information regarding the first task and the map view depicting the at least one of the identified one or more first locations, the identified one or more first storage locations, or the current location of the user device associated with the first user, the one or more third users comprising each of the at least one of a manager or one or more group members tasked with performing the first task.

15. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive, from a user device associated with a first user, a first request for information regarding a first task;
determine a current location of the user device associated with the first user;
in response to receiving the first request, access one or more first databases to obtain information regarding the first task;
compile the information regarding the first task that is obtained from the one or more first databases;
identify one or more first equipment necessary for completing the first task, based at least in part on the compiled information regarding the first task;
identify one or more first locations for performing the first task, based at least in part on the compiled information regarding the first task;
identify one or more first storage locations that have adequate supplies of the identified one or more first equipment and that are within a predetermined distance from one of the current location of the user device associated with the first user or at least one first location among the one or more first locations, based at least in part on the compiled information regarding the first task; and
generate and display, on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user.

16. The apparatus of claim 15, wherein the apparatus comprises one of a processor of the user device running a software application (“app”), a workflow control system, a workflow coordination system, a server computer over a network, a cloud-based computing system over a network, or a distributed computing system.

17. A system, comprising:
a user device associated with a first user, the user device comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the user device to:
send a first request for information regarding a first task; and
send location information regarding the user device;
a computing system, comprising:
at least one second processor; and
a second non-transitory computer readable medium communicatively coupled to the at least one second processor, the second non-transitory computer readable medium having stored thereon computer software comprising a second set of instructions that, when executed by the at least one second processor, causes the computing system to:
receive, from the user device associated with the first user, the first request for information regarding a first task;
determine a current location of the user device associated with the first user based on the location information regarding the user device that is received from the user device;
in response to receiving the first request, access one or more first databases to obtain information regarding the first task;
compile the information regarding the first task that is obtained from the one or more first databases;
identify one or more first equipment necessary for completing the first task, based at least in part on the compiled information regarding the first task;
identify one or more first locations for performing the first task, based at least in part on the compiled information regarding the first task;
identify one or more first storage locations that have adequate supplies of the identified one or more first equipment and that are within a predetermined distance from one of the current location of the user device associated with the first user or at least one first location among the one or more first locations, based at least in part on the compiled information regarding the first task; and
generate and display, on the user device associated with the first user, one or more user interface screens, the one or more user interface screens displaying the compiled information regarding the first task and displaying a map view depicting at least one of the identified one or more first locations, the identified one or more first storage locations, or the current location of the user device associated with the first user.

18. The system of claim 17, wherein the computing system comprises one of a processor of the user device running a software application (“app”), a workflow control system, a workflow coordination system, a server computer over a network, a cloud-based computing system over a network, or a distributed computing system.

19. A method, comprising:
tracking and coordinating among at least one of one or more users, one or more vehicles, or one or more inventory equipment for assisting the one or more users in performing one or more tasks.
